(19) United States
(12) Patent Application Publication
(10) Pub. No.: US 2013/0100578 A1
(43) Pub. Date: Apr. 25, 2013

(54) MULTILAYER CERAMIC ELECTRONIC PART

(71) Applicants: Ju Myung SUH, Anyang (KR); Sang Huk Kim, Suwon (KR); Seon Ki Song, Anyang (KR); Jun Hee Kim, Hwaseong (KR); Jae Sung Park, Suwon (KR)

(72) Inventors: Ju Myung SUH, Anyang (KR); Sang Huk Kim, Suwon (KR); Seon Ki Song, Anyang (KR); Jun Hee Kim, Hwaseong (KR); Jae Sung Park, Suwon (KR)

(73) Assignee: SAMSUNG ELECTRO-MECHANICS CO., LTD.

(21) Appl. No.: 13/408,286

(22) Filed: Feb. 29, 2012

(30) Foreign Application Priority Data
Oct. 21, 2011 (KR) 10-2011-0108013

(51) Int. Cl. H01G 4/12

(52) U.S. Cl. 361/321.2

(57) ABSTRACT

There is provided a multilayer ceramic electronic part, including: a ceramic body having a plurality of dielectric layers laminated therein; a plurality of inner electrode layers formed on at least one surface of each dielectric layer; and margin dielectric layers formed on a margin part of each dielectric layer, on which the inner electrode layers are not formed, and having a dielectric grain size smaller than that of the dielectric layers.

### CROSS-REFERENCE TO RELATED APPLICATIONS

This application claims the priority of Korean Patent Application No. 10-2011-0108013 filed on Oct. 21, 2011, in the Korean Intellectual Property Office, the disclosure of which is incorporated herein by reference.

### BACKGROUND OF THE INVENTION

1. Field of the Invention

The present invention relates to a multilayer ceramic electronic part.

2. Description of the Related Art

In general, a capacitor, an inductor, a piezoelectric element, a varistor, and a thermistor may be electronic parts manufactured using a ceramic material.

Among these ceramic electronic parts, a multilayer ceramic capacitor (MLCC) is advantageous due to a small size, high capacitance, and easy mountability.

This multilayer ceramic capacitor is a chip type condenser that is mounted on a printed circuit board of an electronic product such as a computer, a personal digital assistant (PDA), a cellular phone, or the like, to perform charging or discharging electricity. The multilayer ceramic capacitor has various sizes and lamination types depending on intended purpose and capacitance.

In particular, as electronic products have recently become smaller, microminiaturization and ultra-high capacitance of a multilayer ceramic capacitor have been also demanded.

Accordingly, a multilayer ceramic capacitor in which dielectric layers and inner electrode layers are thinned for miniaturization while a large number of dielectric layers are laminated for ultra-high capacitance, has been manufactured.

Meanwhile, a thermal transfer lamination method, according to which a thin film sheet is transferred at high temperature and voltage conditions, was used in order to improve laminatability in the related art. In this case, an inner electrode layer is stretched, causing an increase in defects in a green chip.

Further, during a firing procedure, fine powder contained in a paste forming the inner electrode layer may be diffused into a dielectric layer, leading to abnormal grain growth of dielectric grains in contact with the inner electrode layer, thereby deteriorating the reliability of a multilayer ceramic electronic part.

### SUMMARY OF THE INVENTION

An aspect of the present invention provides a multilayer ceramic capacitor having improved reliability.

According to an aspect of the present invention, there is provided a multilayer ceramic electronic part, including: a ceramic body having a plurality of dielectric layers laminated therein; a plurality of inner electrode layers formed on at least one surface of each dielectric layer; and margin dielectric layers formed on a margin part of each dielectric layer, on which the inner electrode layers are not formed, and having a dielectric grain size smaller than that of the dielectric layers.

A value of a maximum grain size/an average grain size in dielectric grains of the margin dielectric layers may be 3.0 or less.

The value of a maximum grain size/an average grain size in dielectric grains of the margin dielectric layers may be determined by components contained in a ceramic paste composition for forming the margin dielectric layers and contents thereof.

The margin dielectric layers may have a dielectric grain size distribution of 40 to 100.

The margin dielectric layers may be formed of a ceramic paste composition including ceramic powder, a binder, and a dispersant.

The ceramic powder may have a grain size of 80 to 200 nm.

A content of the binder may be 12 to 20 parts by weight based on 100 parts by weight of the ceramic powder. Also, a content of the dispersant may be 2 to 10 parts by weight based on 100 parts by weight of the ceramic powder.

Each of the margin dielectric layers may be formed in at least one of a margin part in a length direction of the multilayer ceramic electronic part and a margin part in a width direction thereof.

Each dielectric layer may have a thickness of 0.01 to 1.0 μm.

Each inner electrode layer may have a thickness of 0.01 to 1.0 μM.

The multilayer ceramic electronic part may further include outer electrodes formed on both end surfaces of the ceramic body and electrically connected to the inner electrode layers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view taken along line A-A′ of FIG. 1;

FIG. 3 is a cross-sectional view taken along line B-B′ of FIG. 1;

FIG. 4 is an exploded perspective view schematically showing a part of the multilayer ceramic capacitor shown in FIG. 1;

FIG. 5 is a partially enlarged view of FIG. 2;

FIG. 6 is a scanning electron micrograph showing a surface of a margin dielectric layer according to an inventive example of the present invention;

FIG. 7 is a scanning electron micrograph showing a surface of a margin dielectric layer according to a comparative example;

FIG. 8 is a graph of distribution versus size for dielectric grains constituting the margin dielectric layers according to the inventive example of the present invention and the comparative example; and

FIGS. 9 and 10 are graphs respectively showing an IR deterioration ratio of the margin dielectric layer according to the Inventive example of the present invention.

### DETAILED DESCRIPTION OF THE INVENTION

Hereinafter, embodiments of the present invention will be described in detail with reference to the accompanying drawings.

However, the invention may be embodied in many different forms and should not be construed as being limited to the embodiments set forth herein.

The embodiments of the present invention are provided so that those skilled in the art may more completely understand the present invention.

In the drawings, the shapes and dimensions may be exaggerated for clarity, and the same reference numerals will be used throughout to designate the same or like components.

In addition, like reference numerals denote parts performing similar functions and actions throughout the drawings.

In addition, unless explicitly described otherwise, “comprising” any components will be understood to imply the inclusion of other components but not the exclusion of any other components.

The present invention relates to a multilayer ceramic electronic part, and a multilayer ceramic electronic part according to an embodiment of the present invention may be a multilayer ceramic capacitor, an inductor, a piezoelectric element, a varistor, a chip resistor, a thermistor, or the like. The multilayer ceramic capacitor will be described below as merely one example of the multilayer ceramic electronic part.

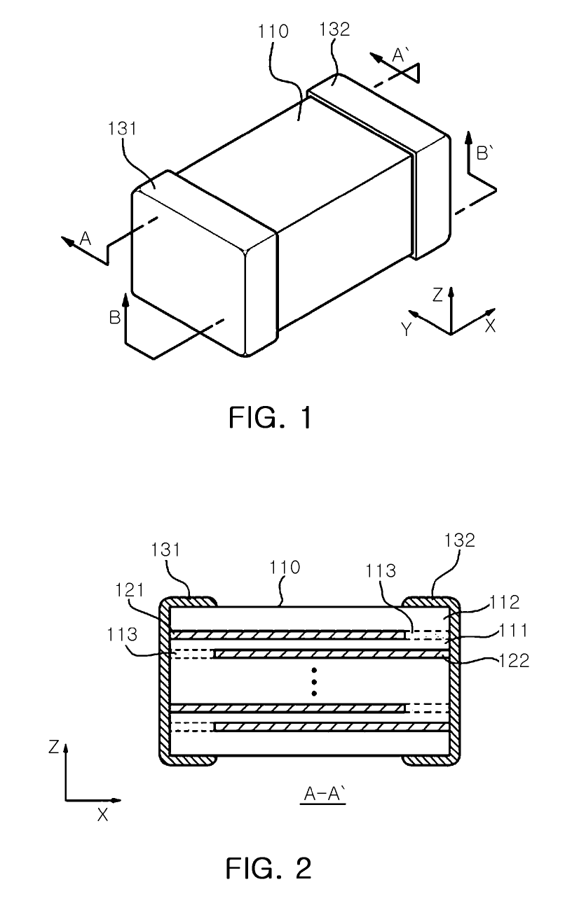

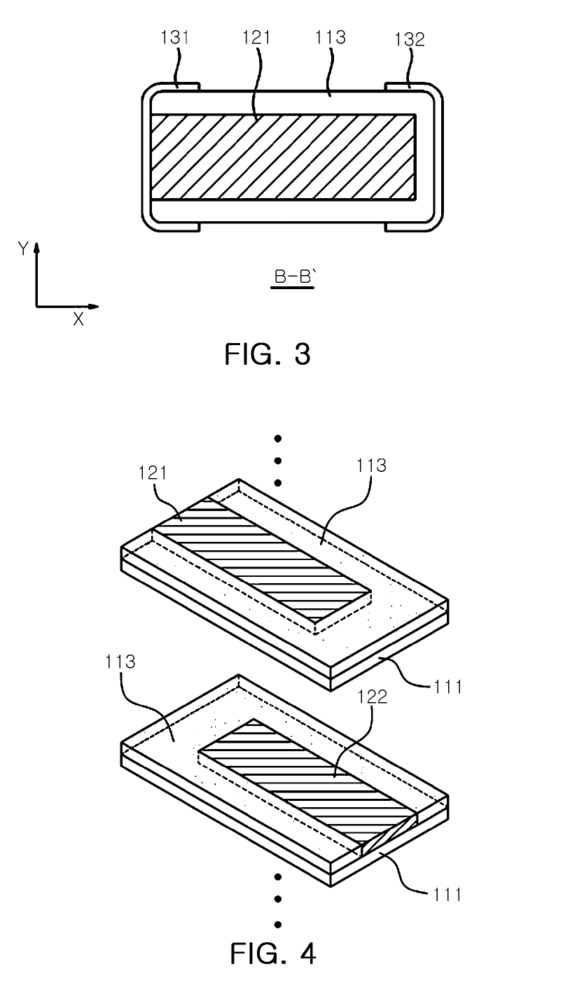

Referring to FIGS. 1 to 5, a multilayer ceramic capacitor according to an embodiment of the present invention may include a ceramic body 110 having a plurality of dielectric layers 111 laminated therein, a plurality of inner electrode layers 121 and 122 formed on at least one surface of each dielectric layer 111, and margin dielectric layers 113 formed on a part of the surface of each dielectric layer 111, on which the inner electrode layers 121 and 122 are not formed, (hereinafter, referred to as a “margin part”).

Here, a size specification of dielectric grains constituting the margin dielectric layers 113, meaning a value of maximum grain size divided by average grain size, is lower than a size specification of dielectric grains constituting dielectric layers 111.

In the embodiment, a “length direction” of the multilayer ceramic capacitor is defined by ‘X’ direction of FIG. 1 and a “width direction” of the multilayer ceramic capacitor is defined by “Y” direction thereof.

A ‘thickness direction (Z direction)’ may have the same concept as a direction in which the dielectric layers 111 are laminated, that is, a ‘lamination direction’.

In general, the ceramic body 110 may have a rectangular parallelepiped shape, but is not limited thereto.

In addition, the size of the ceramic body 110 is not particularly limited, but for example, the ceramic body 110 may be formed to have a size of 0.6 mm×0.3 mm or the like, and thus, this ceramic body 110 may constitute a multilayer ceramic capacitor having high capacitance of 1.0 μF or higher, preferably 22.5 μF or higher.

In addition, a cover dielectric layer 112 having a predetermined thickness may be formed on the outermost surface of the ceramic body 110, if necessary.

The dielectric layers 111 contribute to the formation of capacitance in the capacitor, and a thickness of each dielectric layer 111 may be arbitrarily changed according to a capacity designation of the multilayer ceramic capacitor.

In the embodiment, each dielectric layer 111 may have a thickness of 1.0 μm, preferably, 0.01 to 1.0 μm.

The dielectric layer 111 may contain ceramic powder, for example, a BaTiO₃-based ceramic powder or the like, but is not limited thereto.

The BaTiO₃-based ceramic powder may be (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, or the like, in which, for example, Ca, Zr, or the like is employed in BaTiO₃.

The ceramic powder may have a grain size of 200 nm or less, for example, preferably, 80 to 100 nm, but is not limited thereto.

Also, in addition to this ceramic powder, for example, various ceramic additives, such as transition metal oxides or carbide, rare earth elements, and Mg or Al, organic solvents, plasticizers, binders, dispersants, or the like may be added to the dielectric layer 111 according to the embodiment of the present invention.

Here, the dispersant may have a content of 2 to 10 parts by weight based on 100 parts by weight of the ceramic powder.

The inner electrode layers 121 and 122 may be laminated on ceramic green sheets constituting the dielectric layers 111 and be formed to have each dielectric layer 111 interposed therebetween within the ceramic body 110 through sintering.

These inner electrode layers 121 and 122 may be configured as pairs of a first inner electrode layer (denoted by reference numeral 121) and a second inner electrode layer (denoted by reference numeral 122) having opposite polarities, and may be arranged to be opposed to each other while having a dielectric layer 111 interposed therebetween in the lamination direction.

The first and second inner electrodes 121 and 122 may be formed by using a conductive paste including at least one of a precious metal material, such as palladium (Pd), a palladium-silver (Pd—Ag) alloy, or the like, for example, nickel (Ni), and copper (Cu), but are not limited thereto.

In addition, thicknesses of the first and second inner electrode layers 121 and 122 may be determined depending on an intended use thereof or the like, and for example, the first and second inner electrode layers 121 and 122 may each have a thickness of 1.0 μm or less, preferably 0.01 to 1.0 μm.

Respective ends of the first and second inner electrode layers 121 and 122 may be exposed to end surfaces of the ceramic body 110. The embodiment illustrates that the ends of the first and second inner electrodes 121 and 122 in the length direction (X direction) are alternately exposed to both end surfaces of the ceramic body 110, facing each other.

However, the present invention is not limited thereto, and may be modified to have various structures. For example, the ends of the first and second inner electrode layers 121 and 122 may be exposed to the same surface of the ceramic body 110, or exposed to two or more surfaces of the ceramic body 110, respectively.

First and second outer electrodes 131 and 132 may be formed on both end surfaces of the ceramic body 110. The first and second outer electrodes 131 and 132 may be electrically connected to the ends of the first and second inner electrode layers 121 and 122, which are exposed to the end surfaces of the ceramic body 110.

A conductive material contained in the first and second outer electrodes 131 and 132 is not particularly limited, but may be a conductive material having the same material properties as the inner electrode layer. For example, the first and second outer electrodes 131 and 132 may be formed by using a conductive paste including at least one of a precious metal material, such as palladium (Pd), a palladium-silver (Pd—Ag) alloy, or the like, for example, nickel (Ni), and copper (Cu).

In addition, thicknesses of the first and second outer electrodes 131 and 132 may be appropriately determined according to an intended use thereof or the like, and the respective thicknesses may be for example, 10 to 50 μm.

Meanwhile, when the ceramic powder is used for the conductive paste, large amounts of a binder and a dispersant are required to disperse the ceramic powder.

However, the large amounts of a binder and a dispersant may cause the inner electrode layer to be stretched after the lamination and compression of the multilayer ceramic capacitor, and as a result, an area of the margin part may actually be decreased, as compared with an area of a designed margin part.

According to the embodiment of the present invention, in order to prevent the decrease phenomenon, a paste composition having a composition similar to that of the dielectric layer 111 is used for the inner electrodes 121 and 122, thereby preventing the inner electrode layers 121 and 122 from being stretched.

In other words, the first and second inner electrode layers 121 and 122 are formed on each dielectric layer 111, and the margin dielectric layers 113 are formed on the margin part of each dielectric layer 111 on which the inner electrode layers 121 and 122 are not formed. The margin part may be formed in at least one of a region of the multilayer ceramic capacitor in the width direction (Y direction) and a region thereof in the length direction (X direction), and the embodiment of the present invention illustrates that the margin dielectric layers 113 are formed in both of the margin part in the width direction and the margin part in the length direction.

However, the present invention is not limited thereto, and the margin dielectric layers 113 may be formed in only a part of the margin part in the width direction or the margin part in the length direction.

In addition, the margin dielectric layers 113 may have a height the same as, or similar to, that of the respective first and second inner electrode 121 and 122 formed on each dielectric layer 111.

Therefore, a step occurring between the margin dielectric layers 113 and the first and second inner electrode layers 121 and 122 may be removed, and diffusion of the first and second inner electrode layers 121 and 122 may be prevented.

Meanwhile, when dispersibility of the margin part is degraded during a firing procedure, porosity is increased, causing grains around pores to be grain-grown. Therefore, if the specification of the dielectric grains constituting the margin dielectric layers 113 is too high, dispersibility of the margin part after firing may be degraded to increase porosity, resulting in degraded reliability.

In order to solve these problems, the specification of the dielectric grains constituting the margin dielectric layers 113 may be 3.0 or lower. The specific details will be again described through inventive examples below.

The margin dielectric layers 113 may be formed of a paste composition containing fine grain ceramic powder. In the embodiment of the present invention, the paste composition for forming the margin dielectric layers 113 is called a ceramic paste composition for a margin part (hereinafter, referred to as “a margin ceramic paste composition”).

The size of the dielectric grains constituting the margin dielectric layers 113 may be determined depending on a dispersion degree of the ceramic powder contained in the margin ceramic paste composition.

Also, the size of the dielectric grains constituting the margin dielectric layers 113 may be determined depending on components of the margin ceramic paste composition and contents of the respective components.

According to the embodiment, in order to optimize the size of dielectric grains of the margin dielectric layers 113, a method of controlling the components added to the margin ceramic paste composition, the contents thereof, or the like may be used.

Hereinafter, the margin ceramic paste composition according to the embodiment will be described in detail.

A method of preparing the margin ceramic paste composition will be mainly described in inventive examples, and therefore, the components of the margin ceramic paste composition will be apparent.

In order to prepare the margin ceramic paste composition, first, ceramic powder and a first solvent are mixed to prepare a primary mixture.

The primary mixture may further include a first dispersant and other additives.

As the ceramic powder, powder the same as or similar to, the ceramic powder of the dielectric layer 111 constituting the ceramic body 110 may be used.

This ceramic powder has a normal grain size, which is not particularly limited, but the size thereof may be determined in order to regulate the size of dielectric grains of the margin dielectric layers 113, according to the embodiment.

Considering these facts, the ceramic powder may have an average grain size of 200 nm or less, preferably 80 to 100 nm.

As the first solvent, a material having relatively low viscosity may be used, but is not limited thereto. For example, toluene, ethanol, and a mixed solvent thereof may be used.

Next, the primary mixture is deagglomerated, such that the primary mixture in a slurry state is prepared. In the embodiment, the deagglomeration may be performed by using a bead mill, and deagglomeration conditions may be a casting rate of 6 m/s, a flux of 50 hg/hr (using a high shear micro-mill), and a solid content of about 20 to 40 wt %, preferably 30 wt %.

After the deagglomeration, dispersibility of a ceramic slurry may be confirmed by measuring a grain size, a specific surface area (BET), and a fine shape (SEM) of the ceramic powder.

The ceramic slurry may have a viscosity of 10 to 300 cps, preferably, 50 to 100 cps.

Next, a second solvent, a second dispersant, and a binder are added to the previously prepared primary mixture to prepare a secondary mixture in a paste state.

The secondary mixture in the paste state has a high viscosity suitable for printing, and a viscosity thereof may be in the range of 5,000 to 20,000 cps.

The viscosity of the secondary mixture may be regulated in an appropriate range depending on a printing method. The secondary mixture may have a viscosity of 7,000 to 25,000 cps in a screen printing process. The secondary mixture is in a high-viscosity paste state, and a dispersion process using a method such as 3-roll milling or the like may be performed on the secondary mixture.

The second solvent used in preparing the secondary mixture has a higher boiling point and a higher viscosity as compared to those of the first solvent used in preparing the primary mixture, and a material generally used in preparing a paste may be used for the second solvent.

The specific types of the solvent may be, but is not limited to, for example, a terpineol-based solvent, specifically, dihydro terpineol (DHTA).

The terpineol-based solvent is advantageous to prepare a paste due to the high viscosity thereof, and advantageous for leveling characteristics after printing due to a slow drying rate thereof caused by a high boiling point thereof.

In addition, additives such as a binder and the like may be added to the secondary mixture, together with the secondary solvent.

Any binder that can exhibit physical properties such as thixotropy, adhesion, phase stability, and 3-roll milling possibilities may be used without particular limitation, and, for example, an organic binder such as a polyvinyl butyral resin or the like may be used.

In addition, an ethyl cellulose resin used in a conductive paste for an inner electrode may be further included in the binder.

The binder is coated on a surface of the ceramic powder during the dispersion of the secondary mixture, thereby minimizing agglomeration of the ceramic powder and maintaining dispersion stability.

Also, the binder serves to impart appropriate ranges of viscosity and thixotrophy in order to allow the secondary mixture to be applied to printing methods such as screen printing, gravure printing, and the like.

The content of the binder may be set in consideration of dispersibility of the ceramic powder, as well as laminatability and debindering.

The content of the binder may be set to be in a range similar to the content of the binder contained in a ceramic paste forming the dielectric layer 111.

Also, the content of the binder may be, but is not limited to, 14 to 20 parts by weight based on 100 parts by weight of the ceramic powder.

If the content of the binder is below 14 parts by weight, dispersibility of the ceramic paste may be deteriorated or printing characteristics may be degraded, resulting in increasing porosity of the margin dielectric layers 113.

Also, if the content of the binder is above 20 parts by weight, debindering is difficult, resulting in degrading properties of the multilayer ceramic capacitor.

Also, a plasticizer may be further added to the secondary mixture. The plasticizer may be a triethylene glycol-based plasticizer, and the content thereof may be 5 to 30 parts by weight, preferably 20 parts by weight, based on the 100 parts by weight of the ceramic powder, but is not limited thereto.

Meanwhile, the first solvent may be removed before the secondary mixture is prepared.

The first solvent may be volatilized and removed by a distiller due to a low boiling point thereof.

When the primary solvent is removed, the primary mixture in a slurry state may become a wet cake state.

Therefore, the second solvent used in the secondary mixture is added to the primary mixture in the wet cake state to prepare the secondary mixture in the paste state.

Here, it is preferable to completely remove the first solvent, but a part of the first solvent may not be removed to remain in the secondary mixture.

When the first solvent remains as above, there may be a risk that the dielectric layer 111 will be damaged. Therefore, a removal rate of the first solvent may be preferably as high as possible.

However, the addition of the second dispersant, the binder, or the second solvent may cause the removal of the first solvent to be difficult. Therefore, in order to increase the removal rate of the primary solvent, the first solvent may be removed before the addition of the second solvent, the second dispersant, and the binder for forming the secondary mixture.

In general, metal powder for forming the inner electrode layers 121 and 122 or ceramic powder having a large average grain size may be dispersed through a 3-roll milling process at high viscosity.

However, since ceramic powder having a small average grain size has a large specific surface area and high hardness, dispersibility thereof is difficult to secure at high viscosity.

Further, ceramic powder having a smaller grain size needs to be applied to microminiaturization and ultra thin film type multilayer ceramic capacitors, and in this case, securing dispersibility thereof is more difficult.

For this reason, when the dispersibility of ceramic powder is not sufficiently secured, the porosity of the margin dielectric layers 113 is increased after sintering, resulting in deteriorating reliability.

According to the embodiment, the first solvent having a low viscosity in accordance with fine-grain ceramic powder is used and deagglomeration and dispersion are performed, whereby the agglomeration of the ceramic powder is minimized to secure dispersibility thereof.

Hereinafter, the second solvent is used to thereby prepare a high-viscosity paste for printing. Therefore, fine-grain ceramic powder may be included in the second solvent.

Also, the size specification of the dielectric grains of the margin dielectric layers 113 may be 3.0 or less by using the ceramic paste having dispersibility superior than that of the existing paste.

Hereinafter, a method of manufacturing the multilayer ceramic capacitor according to the embodiment of the present invention will be described.

First, a plurality of ceramic green sheets are prepared.

A slurry is prepared by mixing ceramic powder, a binder, and a solvent and molded into a sheet shape having a thickness of several micrometers (μm) using a doctor blade method to fabricate the plurality of ceramic green sheets.

The slurry may be a ceramic green sheet slurry for forming the dielectric layer 111 of the ceramic body 110 and the cover dielectric layer 112.

Next, a conductive paste for an inner electrode is applied to the ceramic green sheets to form the first and second inner electrode layers 121 and 122.

The first and second inner electrode layers 121 and 122 may be formed by a screen printing method or a gravure printing method.

Next, the margin dielectric layers 113 are formed on a margin part of each ceramic green sheet, on which the inner electrode layers 121 and 122 are not formed.

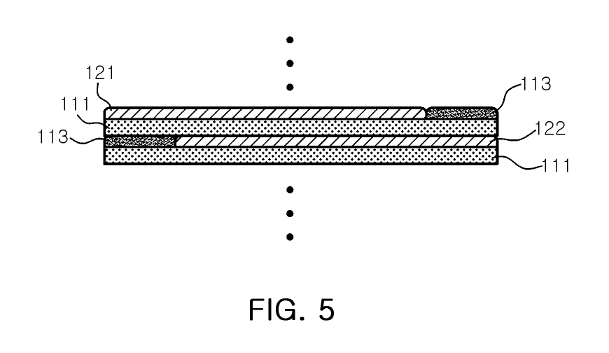

Here, the ceramic paste for a multilayer ceramic capacitor according to the embodiment of the invention as described above is printed on the margin part of each ceramic green sheet on which the first and second inner electrode layers 121 and 122 are not formed, and then fired, thereby forming the margin dielectric layers 113 shown in FIGS. 4 and 5.

Next, the plurality of ceramic green sheets thus obtained are laminated, and then pressure is applied thereto in the lamination direction, thereby compressing the laminated ceramic green sheets and the first and second inner electrode layers 121 and 122 to each other.

By doing so, a ceramic laminate, in which the ceramic green sheets and the first and second inner electrode layers 121 and 122 are alternately laminated, is fabricated.

Here, the inner electrode layers 121 and 122 may be stretched or protruded outwardly of the ceramic green sheets during the compressing.

However, according to the embodiment of the present invention, the diffusion of the first and second inner electrode layers 121 and 122 may be prevented by the margin dielectric layers 131 formed on the margin part of each ceramic green sheet, on which the first and second inner electrode layers 121 and 122 are not formed, the margin dielectric layers 131 being formed of the ceramic paste printed thereon.

Further, the occurrence rate of a step due to the first and second inner electrode layers 121 and 122 in the ceramic body 110 may be reduced.

Next, the ceramic laminate is cut into units of a region corresponding to one capacitor and individualized into each chip.

At the time of cutting, the ends of the first and second inner electrode layers 121 and 122 may be alternately exposed to both end surfaces of the individualized chip.

Then, the individualized chip is fired at a temperature of, for example, 1050 to 1200□, whereby the ceramic body 110 may be manufactured.

Then, the first and second outer electrodes 131 and 132 cover the end surfaces of the ceramic body 110 and are electrically connected to the first and second inner electrode layers 121 and 122 exposed to the end surfaces of the ceramic body 110. Thereafter, surfaces of the first and second outer electrodes 131 and 132 may be plated by using nickel, tin, or the like.

A ceramic paste composition according to the related art and the margin ceramic paste compositions according to inventive examples of the present invention, which are prepared by using different content amounts of dispersant and ceramic powder having different grain sizes, were used to form dielectric margin layers, respectively. Then, several characteristics thereof were measured and are shown in Tables 1 and 2 below.

Samples 1 to 4 listed in Table 1 were respectively obtained by using the margin ceramic paste compositions, which are different in view of the content of a dispersant but the same in view of other conditions.

Samples 5 to 7 listed in Table 2 below were respectively obtained by using the margin ceramic paste compositions, which are different in view of a grain size of ceramic powder but the same in view of other conditions.

TABLE 1

| | Sample 1 | Sample 2 | Sample 3 | Sample 4 |
|---|---|---|---|---|
| Content of dispersant | 2.0 | 3.0 | 4.0 | 5.0 |
| (wt %/BT) | | | | |
| Dispersibility Rmax (μm) | 0.048 | 0.012 | 0.007 | 0.008 |
| Dry film density (g/cm³) | 3.18 | 3.42 | 3.54 | 3.51 |
| Average grain size (nm) | 183.2 | 181.3 | 176.9 | 178.6 |
| Maximum grain size (nm) | 727.4 | 529.7 | 428.8 | 441.6 |

### <Characteristics and Dielectric Grain Sizes of a Margin Dielectric Layer According to the Content of Dispersant in a Margin Ceramic Paste Composition>

Referring to Table 1, as for each of Samples 2 to 4, the content of dispersant contained in the margin ceramic paste composition was regulated, and thus, Samples 2 to 4 showed that dispersibility of the margin dielectric layers 113 after firing was 0.012 μm or less for each sample, and showed that the maximum grain size was 529.7 nm or less and the average grain size was 181.3 nm or less for each sample.

On the other hand, the content of dispersant for Samples 1 was small, and thus Sample 1 showed that dispersibility of the margin dielectric layer 113 after firing was 0.048 μm, and that maximum grain size was 727.4 nm, while the average grain size was 183.2 nm. It can be seen that the maximum grain size for Sample 1 was relatively large.

TABLE 2

| | Sample 5 | Sample 6 | Sample 7 |
|---|---|---|---|
| Grain size of ceramic powder (nm) | 50 | 80 | 100 |
| Dispersibility Rmax (μm) | 0.021 | 0.007 | 0.012 |
| Dry film density (g/cm³) | 3.38 | 3.54 | 3.61 |
| Average grain size (nm) | 159.8 | 176.9 | 207.2 |
| Maximum grain size (nm) | 480.6 | 428.8 | 641.5 |

### <Characteristics and Dielectric Grain Sizes of a Margin Dielectric Layer According to the Grain Size of Ceramic Powder in a Margin Ceramic Paste Composition>

Referring to Table 2, as for Samples 5 and 6, the grain size of ceramic powder contained in the margin ceramic paste composition was 80 nm or less, and thus, Samples 5 and 6 showed that the maximum grain sizes of the margin dielectric layers 113 after firing were 480.6 nm and 428.8 nm, respectively, and the average grain sizes thereof were 159.8 nm and 176.9 nm, respectively.

On the other hand, the grain size of ceramic powder for Sample 7 was 100 nm, larger than that of Samples 5 and 6, and thus, Sample 7 showed that the maximum grain size of the margin dielectric layer 113 after firing was 641.5 μm, and the average grain size was 207.2 nm. It can be seen that the maximum grain size and the average grain size for Sample 1 were relatively larger than those of Samples 5 and 6.

In addition, the margin ceramic paste composition according to the related art and the margin ceramic paste compositions prepared according to the inventive examples of the present invention were used to form margin dielectric layers 113, respectively, and characteristics thereof were shown in Table 3 below.

Samples A to D listed in Table 3 below were respectively obtained by using the margin ceramic paste compositions different in view of the content of binder but the same in view of other conditions.

TABLE 3

| | Sample | Sample | Sample | Sample |
|---|---|---|---|---|
| | A | B | C | D |
| Content of binder | 13 | 14 | 15 | 16 |
| (wt %/BT) | | | | |
| Dispersibility Rmax (μm) | 0.041 | 0.021 | 0.007 | 0.075 |
| Dry film density (g/cm³) | 3.40 | 3.38 | 3.54 | 3.41 |
| Porosity after firing (%) | 14.3 | 12.3 | 7.3 | 8.6 |
| Average grain size (nm) | 189.8 | 186.8 | 176.9 | 177.2 |
| Maximum grain size (nm) | 687.1 | 497.7 | 428.8 | 512.6 |
| Minimum grain size (nm) | 51.8 | 87.8 | 65.7 | 84.2 |
| Size specification of | 3.620 | 2.664 | 2.424 | 2.893 |
| dielectric grain (spec) | | | | |
| Size distribution (±nm) | 102.2 | 74.7 | 50.21 | 59.3 |
| BDV distribution (V) | 34 | 28 | 6 | 11 |
| IR deterioration chip (%) | 51 | 7 | 2 | 10 |

### <Characteristics and Dielectric Grain Sizes of a Margin Dielectric Layer According to the Content of Binder in a Margin Ceramic Paste Composition>

Referring to Table 3, the content of the binder contained in the margin ceramic paste composition for each of Samples B to D was controlled, and thus, Samples B to D showed that the maximum grain size after firing of the margin dielectric layer 113 did not exceed 520 nm and the size distribution was 75±nm for each sample.

On the other hand, the content of the binder used in Sample A as a comparative example was small, and thus dispersion thereof was not smooth, resulting in severe grain agglomeration. Therefore, Sample A showed that the porosity of the margin dielectric layers 113 after firing was 14.3%, the maximum value in Samples A to D.

Further, non-grown grains having a grain size of above 650 nm were found in Sample A, and also, the size distribution in Sample A exceeded 100±nm.

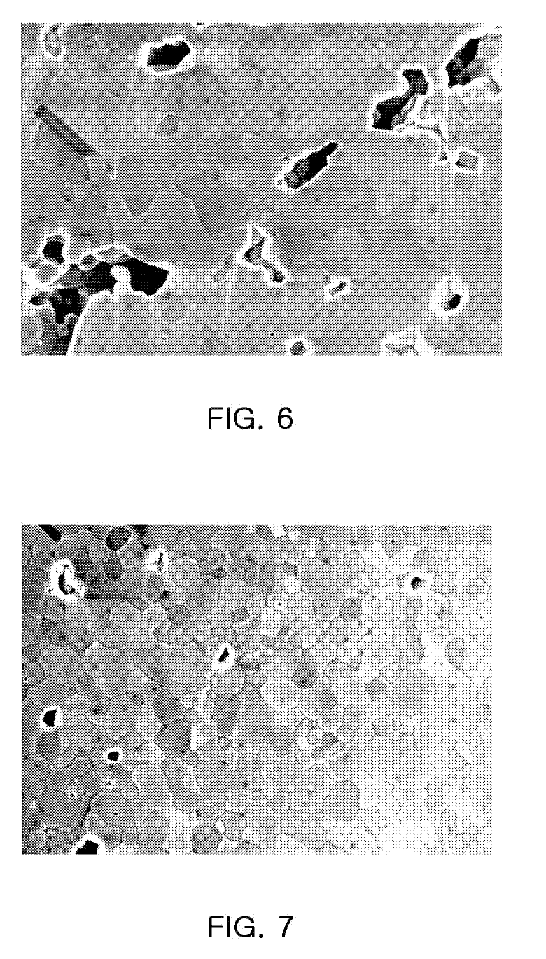

Meanwhile, FIG. 6 shows a scanning electron microscope (SEM) image obtained by scanning a fine structure of Sample 1, and FIG. 7 is a scanning electron microscope (SEM) image obtained by scanning a fine structure of Sample C as the most preferable result.

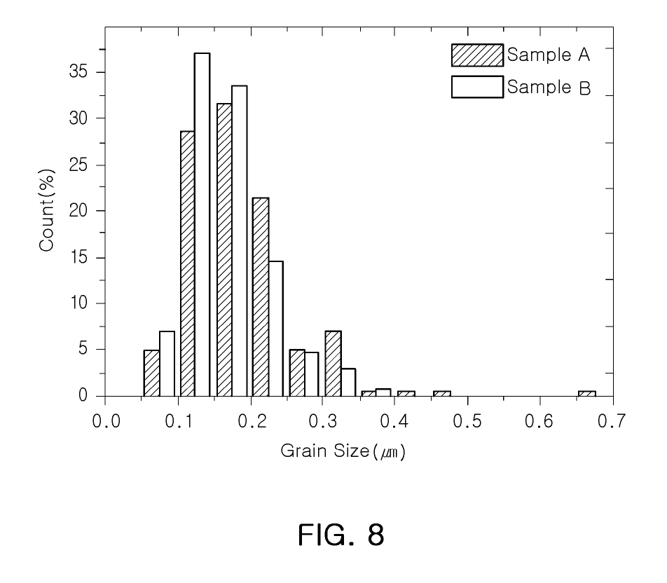

Further, FIG. 8 is a graph showing distribution versus size for dielectric grains in Samples A and C.

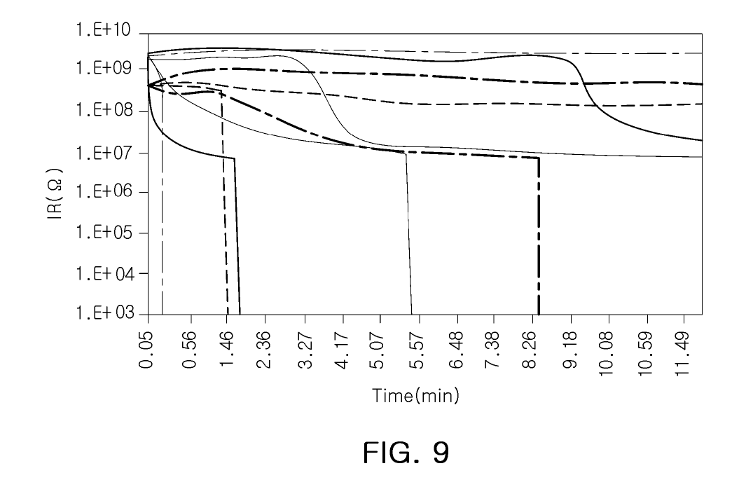

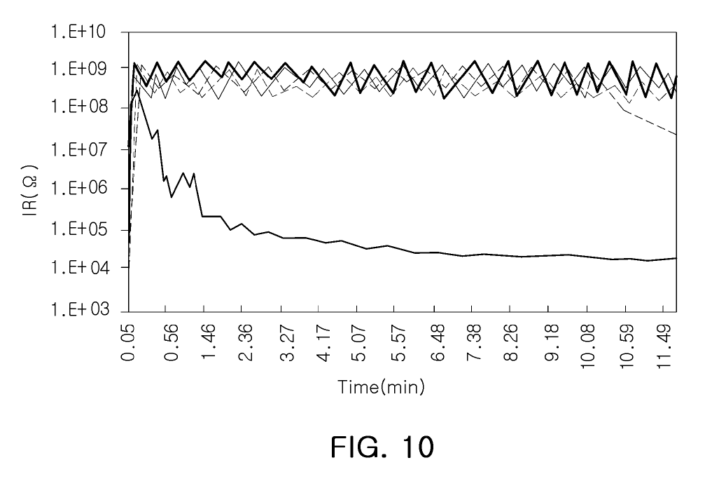

Further, FIGS. 9 and 10 are graphs respectively showing an IR deterioration ratio of the margin dielectric layer according to the Inventive example of the present invention.

Referring to Table 3, and FIGS. 6 to 10, in a case of Sample C in which the content of the binder is 15 wt %, the margin dielectric layers 113 had dispersibility of 0.007 μm and porosity of 7.3%, which were the most excellent, and had the maximum grain size of 428.8 nm and the size distribution of 50.21±nm, which were the lowest.

Contrary to this, in the case of Sample A, the margin dielectric layers 113 had dispersibility of 0.041 μM and porosity of 14.3%, and had the maximum grain size of 687.1 nm and the size distribution of 102.2±nm, which were the worst.

Table 3 above showed results of 8585 Test as a reliability test, and the results were obtained by testing 400 chips for 12 hours, in the conditions of n=400/lot, 85 □, 85% RH, and 6.5 V/9.45V.

Referring to this, in the case of Sample B having low dispersibility, it can be seen that the number of chips deteriorated at the time of reliability test was increased. In addition, referring to FIGS. 9 and 10, it can be seen that deterioration occurred more severely in Sample A, which is the comparative example, as compared to that of Samples B to D, which are the inventive examples of the present invention.

In other words, according to the embodiment, it can be seen that there is a favorable range of the size specification of dielectric grains for reducing porosity of the margin dielectric layers 113 after firing.

Therefore, referring to Table 3 and FIGS. 6 to 10, as for Samples B to D, the content of the binder contained in the margin ceramic paste composition is controlled to be 14 wt % to 16 wt %, and thus, they showed that BDV distribution and IR deterioration were superior for each sample.

In other words, if the size specification of dielectric grains is 3.0 or less, BDV distribution was 30 or less, and the occurrence rate of IR deterioration chip are low, which is 10% or less, and thus, it can be determined that reliability of the multilayer ceramic capacitor was improved.

As set forth above, according to the embodiment of the present invention, a high-capacity multilayer ceramic electronic part having excellent reliability can be realized.

While the present invention has been shown and described in connection with the exemplary embodiments, it will be apparent to those in the art that modifications and variations can be made without departing from the spirit and scope of the invention as defined by the appended claims.

Accordingly, various forms of substitutions, modifications and alterations may be made by those skilled in the art without departing from the spirit of the prevent invention defined by the accompanying claims. These substitutions, modifications and alterations are considered as being within the scope of the present invention.

What is claimed is:

1. A multilayer ceramic electronic part, comprising:
a ceramic body having a plurality of dielectric layers laminated therein;
a plurality of inner electrode layers formed on at least one surface of each dielectric layer; and
margin dielectric layers formed on a margin part of each dielectric layer, on which the inner electrode layers are not formed, and having a dielectric grain size smaller than that of the dielectric layers.

2. The multilayer ceramic electronic part of claim 1, wherein a value of a maximum grain size/an average grain size in dielectric grains of the margin dielectric layers is 3.0 or less.

3. The multilayer ceramic electronic part of claim 2, wherein the value of a maximum grain size/an average grain size in dielectric grains of the margin dielectric layers is determined by components contained in a ceramic paste composition for forming the margin dielectric layers and contents thereof.

4. The multilayer ceramic electronic part of claim 1, wherein the margin dielectric layers have a dielectric grain size distribution of 40 to 100.

5. The multilayer ceramic electronic part of claim 1, wherein the margin dielectric layers are formed of a ceramic paste composition including ceramic powder, a binder, and a dispersant.

6. The multilayer ceramic electronic part of claim 5, wherein the ceramic powder has a grain size of 80 to 200 nm.

7. The multilayer ceramic electronic part of claim 5, wherein a content of the binder is 12 to 20 parts by weight based on 100 parts by weight of the ceramic powder.

8. The multilayer ceramic electronic part of claim 5, wherein a content of the dispersant is 2 to 10 parts by weight based on 100 parts by weight of the ceramic powder.

9. The multilayer ceramic electronic part of claim 1, wherein each of the margin dielectric layers is formed in at least one of a margin part in a length direction of the multilayer ceramic electronic part and a margin part in a width direction thereof.

10. The multilayer ceramic electronic part of claim 1, wherein each dielectric layer has a thickness of 0.01 to 1.0 μm.

11. The multilayer ceramic electronic part of claim 1, wherein each inner electrode layer has a thickness of 0.01 to 1.0 μm.

12. The multilayer ceramic electronic part of claim 1, further comprising outer electrodes formed on both end surfaces of the ceramic body and electrically connected to the inner electrode layers.
